(19) United States
(12) Patent Application Publication
(10) Pub. No.: US 2013/0324100 A1
(43) Pub. Date: Dec. 5, 2013

(54) POSITION INFORMATION MANAGEMENT SYSTEM, POSITION INFORMATION MANAGEMENT METHOD, COMMUNICATION APPARATUS, AND WIRELESS TERMINAL

(71) Applicant: Yasuo OHASHI, Kanagawa (JP)

(72) Inventor: Yasuo OHASHI, Kanagawa (JP)

(73) Assignee: RICOH COMPANY, LTD., Tokyo (JP)

(21) Appl. No.: 13/889,508

(22) Filed: May 8, 2013

(30) Foreign Application Priority Data
May 29, 2012 (JP) 2012-122377

(51) Int. Cl. H04W 4/02

(52) U.S. Cl. CPC H04W 4/02
USPC 455/418; 455/456.1

(57) ABSTRACT

A position information management system which includes a communication apparatus and a wireless terminal which communicates with the communication apparatus is disclosed. The communication apparatus includes a storage unit which stores therein position information of the communication apparatus and operation control information which is determined in accordance with the position information of the communication apparatus and which controls an operation of the wireless terminal; and a position information transmitting unit which transmits, to the wireless terminal, the position information and the operation control information stored in the storage unit. The wireless terminal includes a position information receiving unit which receives the position information and the operation control information by the communication apparatus; and an operation control unit which controls an operation of the wireless terminal in accordance with the operation control information received by the position information receiving unit.

### TECHNICAL FIELD

The present invention relates to a position information management system, a position information management method, a communication apparatus, and a wireless terminal.

### BACKGROUND ART

Various position information management systems are being proposed for grasping and managing a position of a wireless terminal, or a person or an article having the wireless terminal in a facility in which an accurate positioning using GPS, etc., is difficult.

Patent document 1 discloses a system in which a passive RF (Radio Frequency) tag attached to a person is read with a fixed RF (Radio Frequency) reader/writer and a position thereof is reported to a different wireless terminal, etc.

Patent document 2 discloses a system in which a wireless terminal converts an identifier which is wirelessly transmitted from a neighboring transmitter to position specifying information to specify an own position.

Patent document 3 discloses a system in which a wireless terminal receives specific information transmitted from a lighting apparatus and transmits the specific information to a server to specify a position of the wireless terminal.

However, with the system in Patent document 1, a large number of RF (Radio Frequency) reader/writers needs to be installed in order to read the passive RF (Radio Frequency) tag with a narrow range in which communications are possible, which may lead to higher cost in implementing the infrastructure.

Moreover, with the system in Patent document 2, power consumption of the wireless terminal may become high depending on a communications scheme between the wireless terminal and a server.

Furthermore, also in the system in Patent document 3, power consumption of the wireless terminal is not taken into account as in Patent document 2. Moreover, in a server, in order to specify the position of the wireless terminal, it is necessary to search a position associated with the specific information, which could lead to a higher computation cost.

### PATENT DOCUMENTS

Patent document 1: JP4620410B

Patent document 2: JP2010-159980A

Patent document 3: WO2005/086375A

### DISCLOSURE OF THE INVENTION

In light of problems as described above, an object of the present invention is to provide an efficient position information management system, etc.

According to an embodiment of the present invention, a position information management system which includes a communication apparatus and a wireless terminal which communicates with the communication apparatus is provided, wherein the communication apparatus includes a storage unit which stores therein position information of the communication apparatus and operation control information which is determined in accordance with the position information of the communication apparatus and which controls an operation of the wireless terminal; and a position information transmitting unit which transmits, to the wireless terminal, the position information and the operation control information stored in the storage unit, and wherein the wireless terminal includes a position information receiving unit which receives the position information and the operation control information by the communication apparatus; and an operation control unit which controls an operation of the wireless terminal in accordance with the operation control information received by the position information receiving unit.

According to another embodiment of the present invention, a position information management method in a position information management system which includes a communication apparatus, and a wireless terminal which communicates with the communication apparatus is provided, wherein the communication apparatus performs the steps of storing, in a storage unit, position information of the communication apparatus and operation control information which is determined in accordance with the position information of the communication apparatus and which controls an operation of the wireless terminal; and transmitting, to the wireless terminal, the position information and the operation control information stored in the storage unit, and wherein the wireless terminal performs the steps of receiving the position information and the operation control information by the communication apparatus; and controlling the operation of the wireless terminal in accordance with the operation control information received.

According to a further embodiment of the present invention, a communication apparatus which communicates with a wireless terminal is provided, including a storage unit which stores therein position information of the communication apparatus and operation control information which is determined in accordance with the position information of the communication apparatus and which controls an operation of the wireless terminal; and a position information transmitting unit which transmits, to the wireless terminal, the position information and the operation control information stored in the storage unit.

According to yet another embodiment of the present invention, a position information management method in a position information position information management system is provided, including: a communication apparatus which includes a storage unit which stores therein position information of the communication apparatus; a wireless terminal which includes identification information and which communicates with the communication apparatus; and a management server which manages a position of the wireless terminal, wherein the management server further performs the steps of: receiving the identification information and the position information from the communication apparatus; obtaining, from a storage unit which stores therein the communication apparatus identification information and registered position information of the communication apparatus, the registered position information of a communication apparatus which transmitted the position information received by the position information receiving unit and stored in the storage unit; determining whether there is a match between the registered position information and the position information received by the position information receiving unit; and managing a position of the wireless terminal with the identification information and the position information that are determined to match by the determining unit.

According to a further embodiment of the present invention, a wireless terminal which communicates with a communication apparatus is provided, the wireless terminal including a position information receiving unit which receives position information and operation control information by the communication apparatus; and an operation control unit which controls an operation of the wireless terminal received by the position information receiving unit.

Constituting elements, expressions, or an arbitrary combination of constituting elements of the present invention that are applied to a method, an apparatus, a system, a computer program, a recording medium, etc., are also effective as modes of the present invention.

Embodiments of the present invention may provide a position information management system, etc., which efficiently manage position information.

### BRIEF DESCRIPTION OF THE DRAWINGS

Other objects, features, and advantages of the present invention will become more apparent from the following detailed descriptions when read in conjunction with the accompanying drawings, in which:

FIG. 1A is a diagram showing a position information management system according to one embodiment of the present invention;

FIG. 1B is a diagram showing a network which makes up the position information management system according to one embodiment of the present invention;

FIG. 2A is a hardware configuration diagram of a communication apparatus according to one embodiment of the present invention;

FIG. 2B is a hardware configuration diagram of a wireless terminal according to one embodiment of the present invention;

FIG. 2C is a hardware configuration diagram of a management apparatus according to one embodiment of the present invention;

FIG. 2D is a hardware configuration diagram of a management server according to one embodiment of the present invention;

FIG. 3A is a functional block diagram of the communication apparatus according to one embodiment of the present invention;

FIG. 3B is a functional block diagram of the wireless terminal according to one embodiment of the present invention;

FIG. 3C is a functional block diagram of the management apparatus according to one embodiment of the present invention;

FIG. 3D is a functional block diagram of the management server according to one embodiment of the present invention;

FIG. 4 is a diagram showing an example of information held by the communication apparatus according to one embodiment of the present invention;

FIG. 5 is a diagram showing an example of information held by the wireless terminal according to one embodiment of the present invention;

FIG. 6 is a diagram showing an example of a format of position information transmitted by the wireless terminal according to one embodiment of the present invention;

FIG. 7 is a diagram showing an example of information held by the management server according to one embodiment of the present invention;

FIG. 8 is a diagram showing an operational sequence of the position information management system according to one embodiment of the present invention;

FIG. 9A is a diagram showing an example of a search screen of the management server according to one embodiment of the present invention;

FIG. 9B is a diagram showing an example of a search result screen of the management server according to one embodiment of the present invention;

FIG. 10 is a diagram showing an example of an extended format including position information to be transmitted and received between the communication apparatus and the wireless terminal according to one embodiment of the present invention;

FIG. 11 is a diagram showing one example of position information and extension information which are held by the communication apparatus according to one embodiment of the present invention;

FIG. 12 is a diagram showing one example of position information and extension information which are held by the wireless apparatus according to one embodiment of the present invention;

FIG. 13 is a diagram illustrating an example of a content of operation control by “operation control information” according to one embodiment of the present invention;

FIG. 14 is a flowchart showing an operation of a wireless terminal 120 according to the present embodiment 2;

FIG. 15 is a diagram showing position information management system 1-2 which explains one embodiment of the present embodiment 2;

FIG. 16 is a diagram showing position information of a communication apparatus 100 and position information of a communication apparatus 100-2 according to one embodiment of the present invention; and

FIG. 17 is a diagram illustrating an extended format including position information transmitted and received between the communication apparatus and the wireless terminal according to one embodiment of the present invention.

### BEST MODE FOR CARRYING OUT THE INVENTION

### Embodiment 1

Below an embodiment of the present invention is described based on the drawings.

1. System

2. Exemplary hardware configuration

3. Function

4. Operational sequence

(1. System)

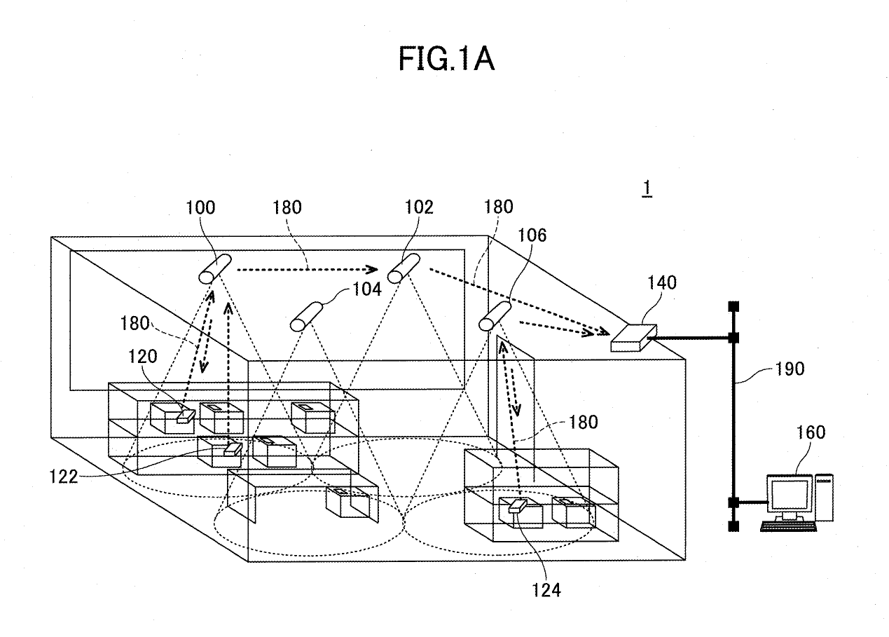

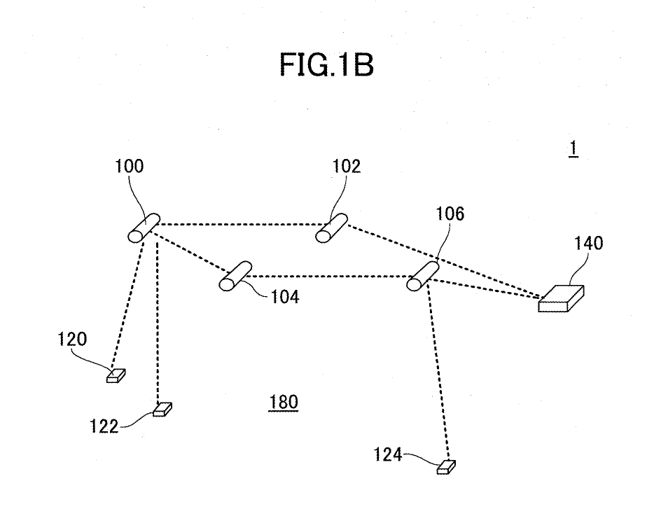

FIG. 1A shows a position information management system 1 according to one embodiment of the present invention. In FIG. 1A are included communication apparatuses 100, 102, 104, 106; wireless terminals 120, 122, 124; a management apparatus 140; a management server 160; a network 180 which includes the communication apparatuses, the wireless terminals, and the management apparatus; and a network 190. Here, the network 180 is a wireless network managed by the management apparatus 140. FIG. 1B shows the communication apparatuses 100, 102, 104, and 106; the wireless terminals 120, 122, 124; and the management apparatus 140, which make up the wireless network in FIG. 1A, being extracted.

The communication apparatuses 100, 102, 104, and 106 that are fixed to a ceiling, etc., of a room, for example, continuously or intermittently transmit wirelessly position information (to be called “position information” below) such as latitude and longitude information, a building floor number, and a building number that is related to a position fixed. The communication apparatuses, which respectively include an independent housing, operate such that power thereof is supplied from a power supply installed in advance, or are embedded in a lighting fixture such as an LED fluorescent tube and operate such that power thereof is supplied from the lighting fixture. The communication apparatuses 100, 102, 104, and 106 transmit position information held respectively thereby to a predetermined range by a wireless signal. The predetermined range is determined by signal strength of a wireless signal used. The communication apparatuses are arranged to cover areas whose positions are to be managed and are configured such that the respective areas do not overlap. Alternatively, they are configured such that any one communication apparatus may be identified based on a strength of a received radio wave on the side which receives the position information even when they overlap. In an example in FIG. 1A, cylindrically-shaped dotted lines which are shown in a lower portion of the respective communication apparatuses show a predetermined range. As a communications scheme which transmits the position information, an indoor messaging system (IMES) may be used, for example.

The wireless terminals 120, 122, and 124 may receive a radio signal transmitted by a nearest communication apparatus out of the communication apparatuses 100, 102, 104, and 106. In the example in FIG. 1A, the respective wireless terminals are attached to a rectangular solid article whose position is to be managed. The wireless terminals 120, 122, and 124 are terminals such as an active tag, etc., which themselves can also transmit radio waves. Below, the wireless terminal 120 is described.

The wireless terminal 120, which is in a range in which a radio signal from the communication apparatus 100 may be received, receives position information of the communication apparatus 100. Receiving of the position information of the communication apparatus 100 is performed by IMES, for example. The wireless terminal 120 transmits to the communication apparatus 100, with position information received, information including own identification information such as a network address, for example. The transmitting is performed via the network 180 by near-field wireless communication such as IEEE 802.15.4 and ZigBee (registered copyright), for example. In this case, as the identification information for the wireless terminal 120, an IEEE extended (MAC) address or an IEEE 802.15.4 short address may be used. The identification information and the position information that are transmitted to the communication apparatus 100 are then transmitted to the management apparatus 140 via the neighboring communication apparatus 102. An operation of transmission and reception in the wireless terminal 120 is performed at a timing which is predetermined in the wireless terminal 120 or at a timing at which a change in acceleration is detected by an acceleration sensor included by the wireless terminal 120.

The management apparatus 140 mutually connects the network 180 and the network 190, and bridges, to the network 190, data transmitted from the network side 180. The management apparatus 140 is installed for each building floor, or for each room separated by a wall, etc., for example. When the network 180 is a PAN (Personal Area Network) by IEEE 802.15.4 and ZigBee (registered copyright) and the network 190 is a LAN based on IEEE 802.3 standards, conversion of communications schemes is performed therebetween. Moreover, when the identification information of the wireless terminal 120 is shown by the IEEE 802.15.4 short address, a conversion is made to the IEEE extended address based on information at the time of configuring the PAN, which converted results are transmitted to the management server 160.

The management server 160 records, with received date and time, the identification information and the position information that are received via the management apparatus 140 and manages a position of the communication apparatus. In the management server 160, an article to be managed that is related to the wireless terminal is recorded in advance. Therefore, these information sets may be used to search for whereabouts of the article to be managed.

The network 180 may be a PAN, which is configured by IEEE 802.15.4 and ZigBee (registered trademark) standards, for example, that connects the respective communication apparatuses 100, 102, 104, and 106; the wireless terminals 120, 122, and 124; and the management apparatus 140. When the PAN is configured by IEEE 802.15.4 and ZigBee (registered trademark) standards, the wireless terminal, the communication apparatus, and the management apparatus respectively include an end device function, a router function, and a coordinator function that are respectively determined by ZigBee (registered trademark) standards. Then, the communication apparatuses and the wireless terminals are subjected to control of the management apparatus at the time of launch, a PAN is configured, and a minimum route to the management apparatus is determined.

The network 190, which is a network connecting the management apparatus 140 and the management server 160, is a LAN determined by the IEEE 802.3 standards, for example.

As described above, in the position information management system 1 according to one embodiment of the present invention, the wireless terminal may use sufficient power to be able to communicate with a nearest communication apparatus to transmit the identification information and the position information to the management server. Moreover, construction of a new infrastructure for installing the communication apparatus is not necessary, making it possible to reduce implementation costs.

The position information of the communication apparatus may be provided via the network 180. In this way, a transmitting unit for transmitting the position information such as IMES becomes unnecessary.

Moreover, when the management apparatus 140 exists nearer relative to the communication apparatus which transmitted the position information, the wireless terminal may transmit the identification information and the position information to the management apparatus 140. In this way, the identification information and the position information may be transmitted to the management server 160 via a shortest route.

Furthermore, functions of the management apparatus 140 may be integrated into the management server 160. In this way, dedicated management apparatuses become unnecessary.

Moreover, the wireless terminal may be a wireless terminal which has an equivalent function as an active tag such as a smart phone, a PDA, a PC, or a smart meter. This makes it possible to manage position information of an existing wireless terminal without attaching a tag.

Furthermore, in addition to the above-described position information, information which specifies a more precise position may be included such as information which shows a section within a room, for example. This makes it possible to perform more precise position management.

Moreover, a target whose position is to be managed may be a person. This makes it possible to manage whereabouts of a person by the system 1.

Furthermore, the network 180 may be configured using a near-field wireless communications such as Bluetooth LE, ANT, Z-Wave, etc., for example. This makes it possible to manage the position information of various wireless terminals. Moreover, the network 190 may include multiple types of networks such as the Internet, for example. This makes it possible to manage the position information of the wireless terminal regardless of a physical positioning between the network 180 and the management server 160.

(2. Exemplary hardware configuration)

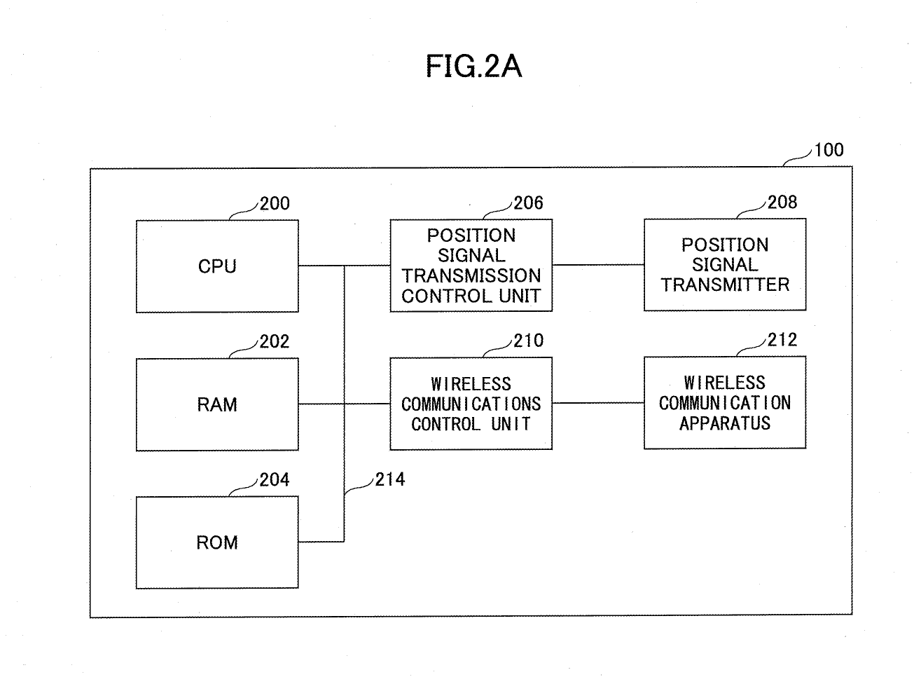

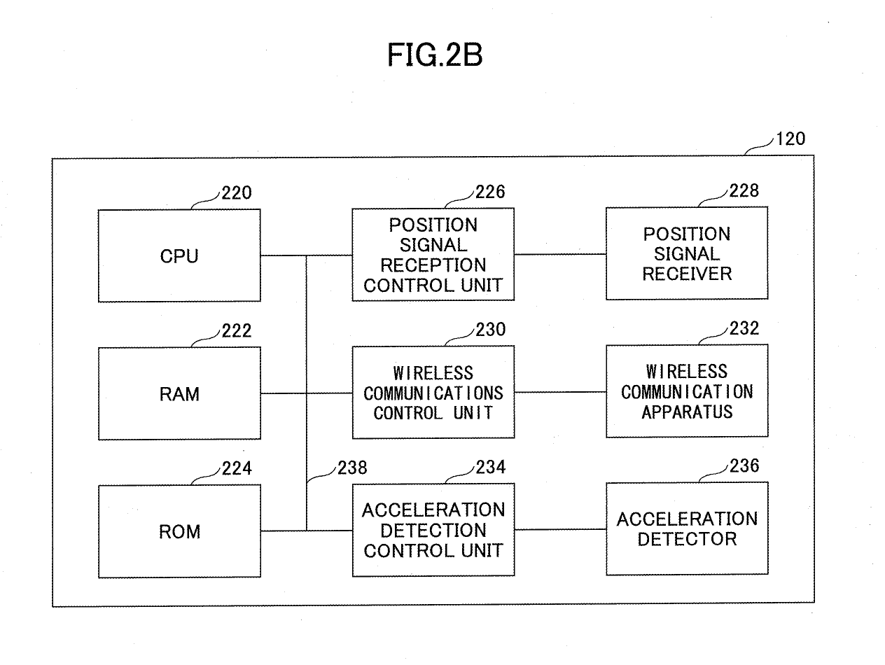

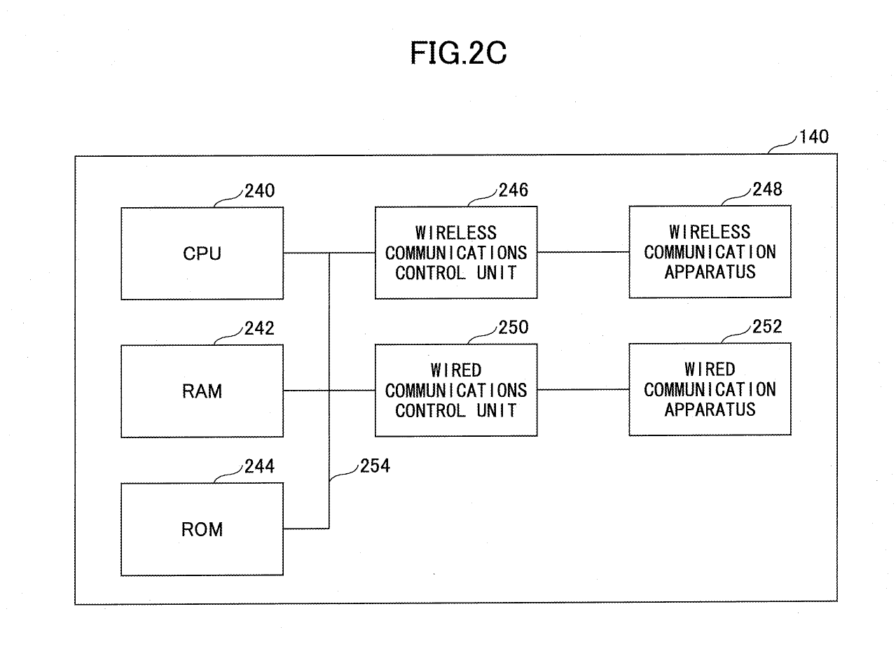

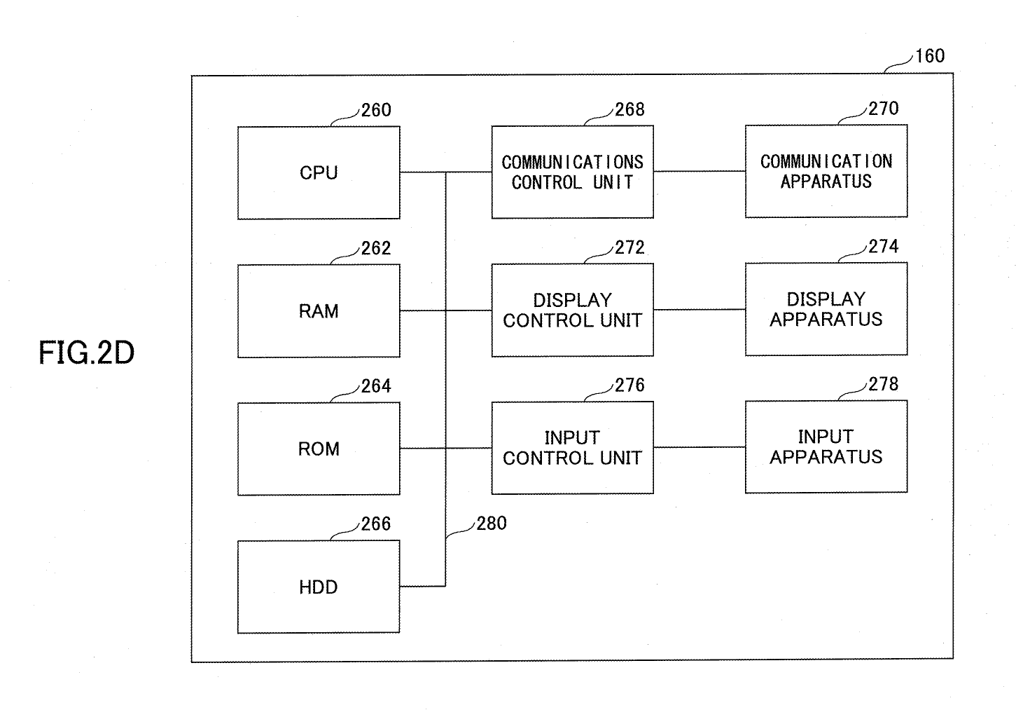

Next, a hardware configuration of the communication apparatus 100, the wireless terminal 120, the management apparatus 140, and the management server 160 that are included in the position information management system 1 are described using FIGS. 2A, 2B, 2C, and 2D.

FIG. 2A shows a hardware configuration of the communication apparatus 100 according to one embodiment of the present invention. The communication apparatus 100 includes a CPU 200, a RAM 202, a ROM 204, a position signal transmission control unit 206, a position signal transmitter 208, a wireless communications control unit 210, a wireless communication apparatus 212, and a bus 214.

The CPU 200 executes programs which perform operational control of the communication apparatus 100. The RAM 202 makes up a work area, etc., of the CPU 200. In addition to the program executed by the CPU 200, the ROM 204 stores position information of the communication apparatus 100. The position signal transmission control unit 206 executes a process for transmitting a positioning signal which shows position information of the communication apparatus 100 via the position signal transmitter 208. The position signal transmitter 208 is an apparatus which includes an antenna for sending a positioning signal such as an IMES, for example. The wireless communications controller 210 executes a wireless communications process via the wireless communication apparatus 212. The wireless communication apparatus 212 is an apparatus including an antenna which can transmit and receive a radio wave which is adapted to IEEE 802.15.4 standards, for example. The bus 214 is electrically connected to the apparatus.

With the above-described configuration, the communication apparatus 100 according to one embodiment of the present invention may transmit the position information to the wireless terminal 120, receive the identification information and the position information from the wireless terminal 120, and transmit these information sets to the management server 160 via the management apparatus 140.

As described above, when the position information is transmitted by wireless communications, the position signal transmission controller 206 and the position signal transmitter 208 become unnecessary.

FIG. 2B shows a hardware configuration of the wireless terminal 120 according to one embodiment of the present invention. The communications terminal 120 includes a CPU 220, a RAM 222, a ROM 224, a position signal reception controller 226, a position signal receiver 228, a wireless communications control unit 230, a wireless communication apparatus 232, an acceleration detection control unit 234, an acceleration detector 236, and a bus 238.

The CPU 220 executes programs which perform operational control of the wireless terminal 120. The RAM 222 makes up a work area, etc., of the CPU 220. In addition to programs executed by the CPU 220, the ROM 224 stores the identification information of the wireless terminal 120 and the position information received from the communication apparatus 100. The position signal reception control unit 226 executes a process for receiving a positioning signal which shows position information via the position signal receiver 228. The position signal receiver 228 is an apparatus including an antenna which receives a positioning signal such as IMES, for example. The wireless communications control unit 230 executes a wireless communications process via the wireless communication apparatus 232. The wireless communication apparatus 232 is an apparatus including an antenna which can transmit and receive a radio wave which is adapted to IEEE 802.15.4 standards, for example. The acceleration detection control unit 234 detects a change in acceleration via the acceleration detector 236. The acceleration detector 236 is a motion sensor which uses an inertial force or magnetism or an acceleration sensor, for example. The bus 238 electrically connects the above-described apparatuses.

With the above-described configuration, the wireless terminal 120 according to one embodiment of the present invention may receive the position information from the communication apparatus 100 and transmit, to the communication apparatus 100, own identification information and the position information. In particular, a transmission or reception operation may be performed at a timing at which the wireless terminal 120 is moved to efficiently transmit the identification information and the position information.

When the wireless terminal 120 is an information terminal such as a smart phone or a PC, there may be provided an input apparatus such as a touch panel, a dial key, a keyboard, a mouse, for example, that accepts an input from a user and an input controller which corresponds thereto. Moreover, there may be provided a display apparatus such as a screen and a corresponding display controller.

Moreover, when the wireless terminal 120 includes a GPS antenna and a corresponding control unit, it may receive a positioning signal using IMES using the antenna and cause it to correspond to the position information management system 1 by only software improvement.

Moreover, the acceleration detection controller 234 and the acceleration detector 236 are arbitrary constituting elements. Without the acceleration detection controller 234 and the acceleration detector 236, an operation of transmission or reception of the wireless terminal 120 is performed at a predetermined interval or time.

Moreover, as described above, when the position information is received by wireless communications, the position signal reception control unit 206 and the position signal receiver 208 become unnecessary.

FIG. 2C shows a hardware configuration of the management apparatus 140 according to one embodiment of the present invention. The management apparatus 140 includes a CPU 240, a RAM 242, a ROM 244, a wireless communications control unit 246, a wireless communication apparatus 248, a wired communications control unit 250, a wired communication apparatus 252, and a bus 254.

The CPU 240 executes programs which perform operational control of the management apparatus 140. The RAM 242 makes up a work area, etc., of the CPU 240. The ROM 244 stores the programs to be executed by the CPU 240 and data to be used by the programs. The wireless communications control unit 246 executes the wireless communications process via the wireless communication apparatus 248. The wireless communication apparatus 248 is an apparatus including an antenna which can transmit and receive a radio wave which is adapted to IEEE 802.15.4 standards, for example. The wired communications control unit 250 executes a communications process in a wired manner via the wired communication apparatus 252. The wired communication apparatus 252 is an apparatus which has a network interface which is adapted to the IEEE 802.3 standards, for example. The bus 254 electrically connects the apparatuses.

With the above-described configuration, the management apparatus 140 according to one embodiment of the present invention may convert a signal from the network 180 which includes the communication apparatus 100 and the wireless terminal 120 into the network 190 which includes the management server 160. Moreover, when the network 180 which makes up the PAN is ZigBee (registered trademark), it may include a function of a coordinator which manages devices which participate in the PAN.

FIG. 2D shows a hardware configuration of the management server 160 according to one embodiment of the present invention. The management server 160 includes a CPU 260, a RAM 262, a ROM 264, an HDD 266, a communications control unit 268, a communication apparatus 270, a display control unit 272, a display apparatus 274, an input control unit 276, an input apparatus 278, and a bus 280.

The CPU 260 executes programs which perform an operational control of the management server 160. The RAM 262 includes a work area, etc., of the CPU 260. The ROM 264 stores programs to be executed by the CPU 260 and data to be used by the programs. The HDD 266 stores information for managing a position of the wireless terminal 120 which is used in the position information management system 1. The communications control unit 268 executes a communications process via the communication apparatus 270. The communication apparatus 270 is an apparatus which includes a network interface which is adapted to IEEE 802.3 standards, for example. The display control unit 272 controls what is to be displayed on the display apparatus 274 according to processing of programs related to position management that are executed on the management server 160. The display apparatus 274 includes a display such as a liquid crystal display or a CRT display, for example. The input control unit 276 processes a signal from the input apparatus 278 such as a keyboard, a mouse, etc., that accepts an input from the user. The bus 280 electrically connects these components.

With the above-described configuration, the management server 160 according to one embodiment of the present invention may manage a position of the wireless terminal 120 and search for whereabouts of the wireless terminal 120.

The HDD 266 may be any storage apparatus including a tape drive, or it may be a storage area which can be accessed via a network.

Moreover, the management server 160 may include a wireless communications control unit and a wireless communication apparatus normally included in the management apparatus 140, and a process thereof may be performed in lieu of the management apparatus 140. This makes it unnecessary to separately provide the management apparatus 140.

(3. Function)

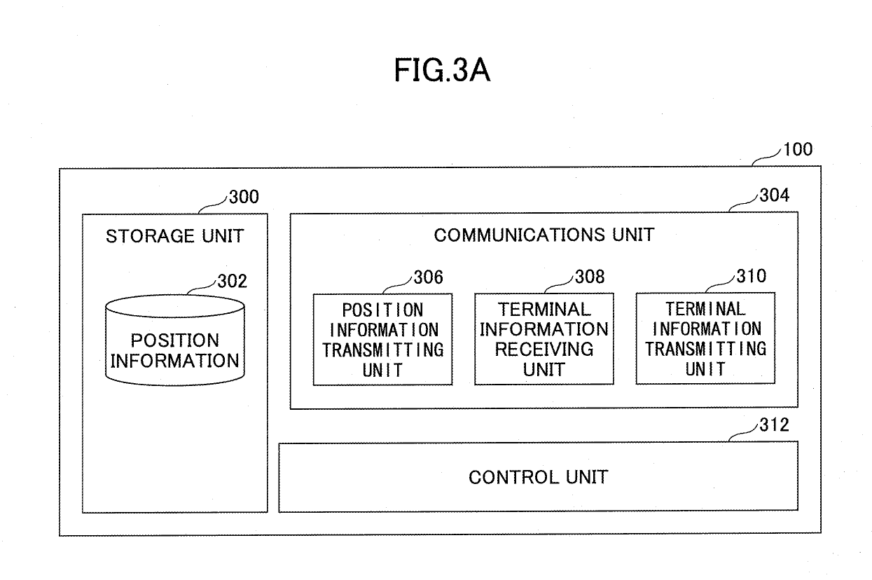

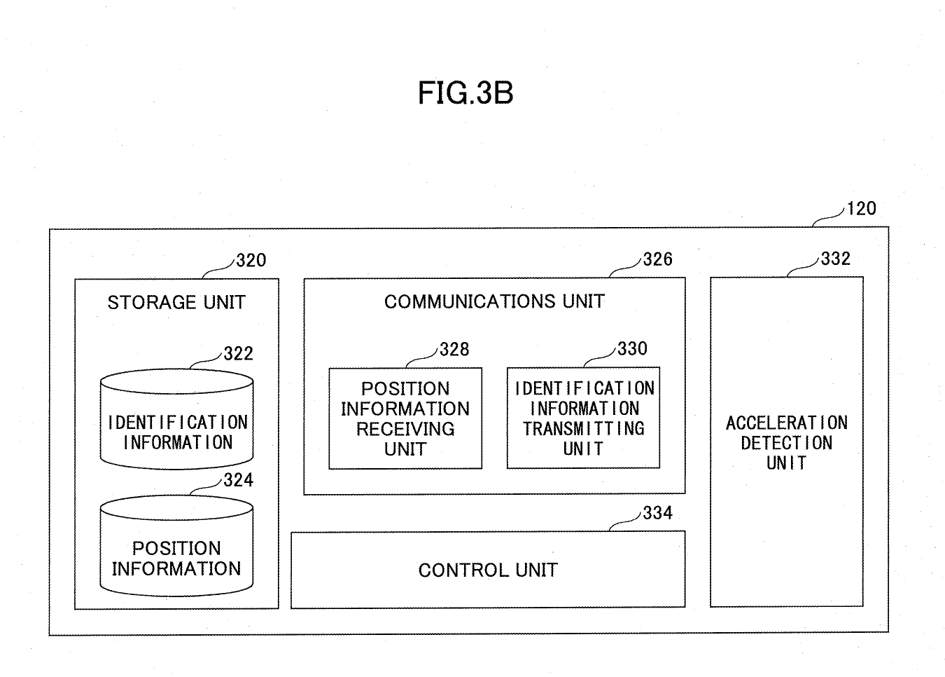

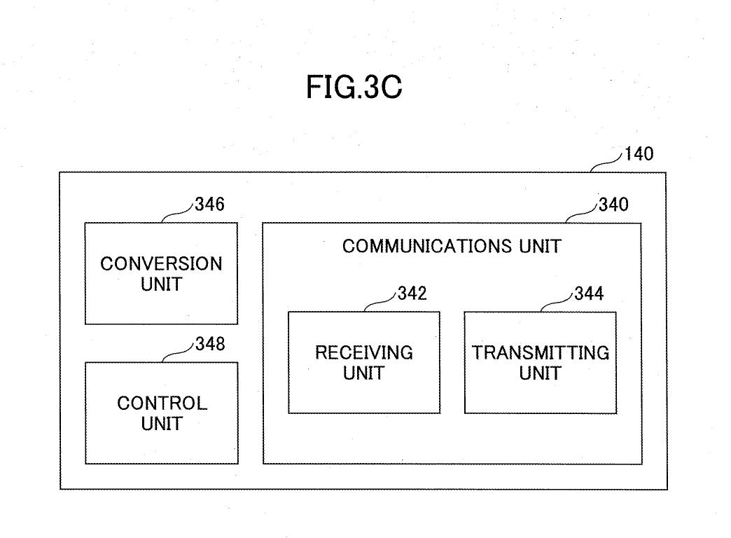

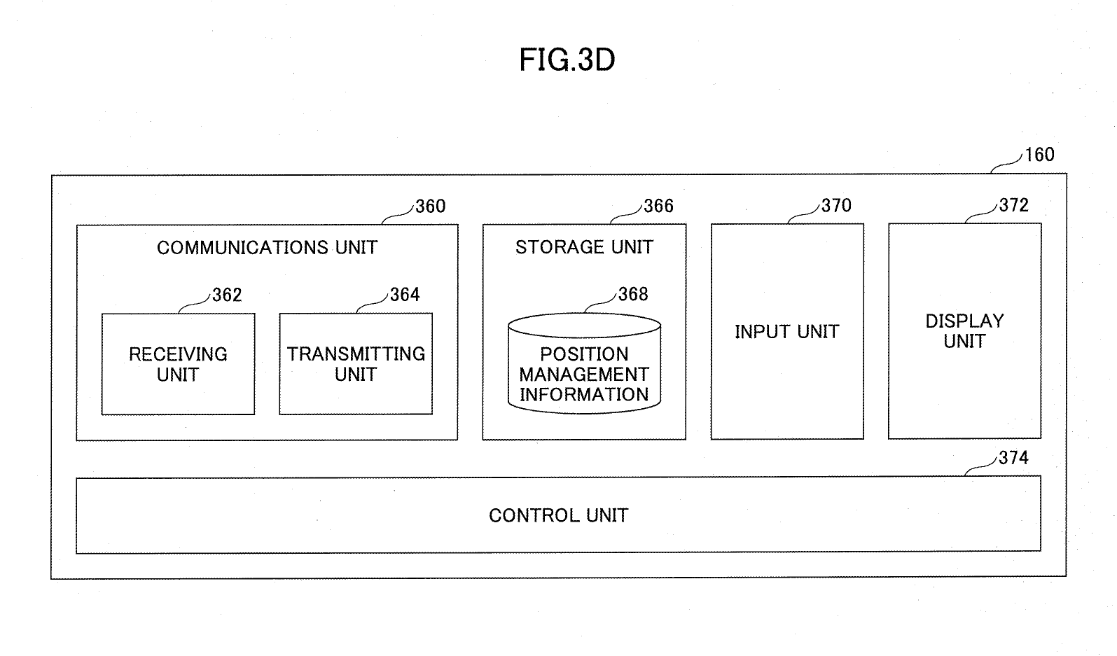

FIG. 3A shows a functional block diagram of the communication apparatus 100 according to one embodiment of the present invention. The communication apparatus 100 according to one embodiment of the present invention includes a storage unit 300, a communications unit 304, and a control unit 312.

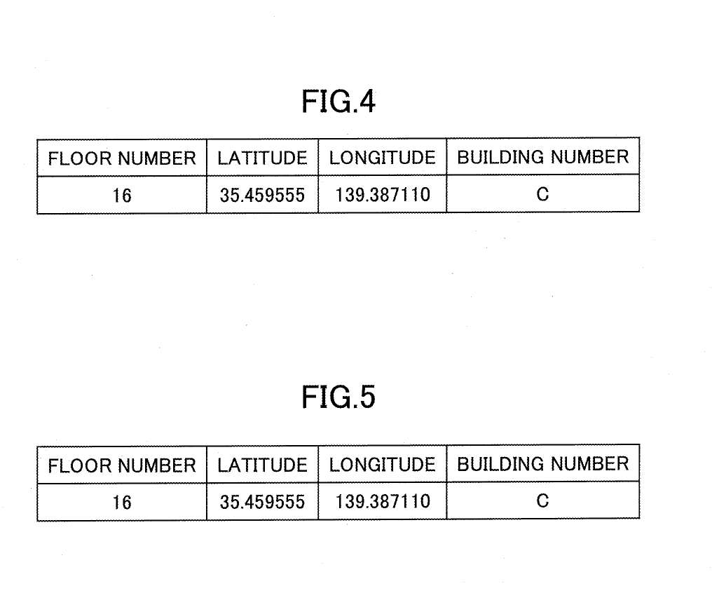

The storage unit 300 stores position information 302 of the communication apparatus 100. An example of a table for storing the position information 302 is shown in FIG. 4. FIG. 4 includes items of the floor number, latitude, longitude, and building number. The floor number shows a floor number of a building on which the communication apparatus 100 is installed. The latitude and the longitude show a latitude and a longitude of a position at which the communication apparatus 100 is located. The building number shows a building number of a building in which the communication apparatus 100 is installed. In an example in FIG. 4, the communication apparatus 100 is located on the 16th floor of a C unit of a certain building and is located at a position which is 35.459555 in latitude and 139.387110 in longitude.

The communications unit 304 includes a position information transmitting unit 306, a terminal information receiving unit 308, and a terminal information transmitting unit 310.

The position information transmitting unit 306 wirelessly transmits in a continuous or intermittent manner, to the wireless terminal 120 in a predetermined range, the position information 302 including information such as latitude and longitude information, the floor number in a building, the building number. The position information 302 is transmitted using a format specified in IMES, for example.

The terminal information receiving unit 308 receives identification information and position information transmitted from the wireless terminal 120.

The terminal information transmission unit 310 transmits, to the management server 160 via the management apparatus 140, the identification information and the position information transmitted from the wireless terminal 120. When the network 180 is provided using ZigBee (registered trademark) standards, the transmission is performed using routing information held by the communication apparatus 100.

The control unit 312 controls an operation of the communication apparatus 100. When the communication apparatus 100 configures a PAN using ZigBee (registered trademark) with the management apparatus 140 and the wireless terminal 120, the control is performed such that the communication apparatus 100 provides a router function.

With the above-described configuration, the communication apparatus 100 according to one embodiment of the present invention may hold position information 302, transmit the position information 302 to the wireless terminal 120, and receive the position information and the identification information of the wireless terminal 120 to transmit the identification information to the management server via the management apparatus 140.

The position information 302 may include additional information such as information showing a section within a room and a name of a building in which a communication apparatus 100 is installed. This makes it possible to perform more precise position management.

FIG. 3B shows a functional block diagram of the wireless terminal 120 according to one embodiment of the present invention. The wireless terminal 120 according to one embodiment of the present invention includes a storage unit 320, a communications unit 326, an acceleration detection unit 332, and a control unit 334.

The storage unit 320 includes identification information 322 and position information 324. The identification information 322 includes information which can specify the wireless terminal 120 on the position information management system 1, such as a network address of the wireless terminal 120. For example, when the network 180 is based on IEEE 802.15.4 and ZigBee (registered trademark) standards, the IEEE 802.15.4 short address or the IEEE extended (MAC) address may be used. The position information 324 is position information 302, which is transmitted from the communication apparatus 100. An example of a table for storing therein the position information 324 is shown in FIG. 5. The configuration is the same as that in FIG. 4.

The communications unit 326 includes the position information receiving unit 328 and the identification information transmitting unit 330.

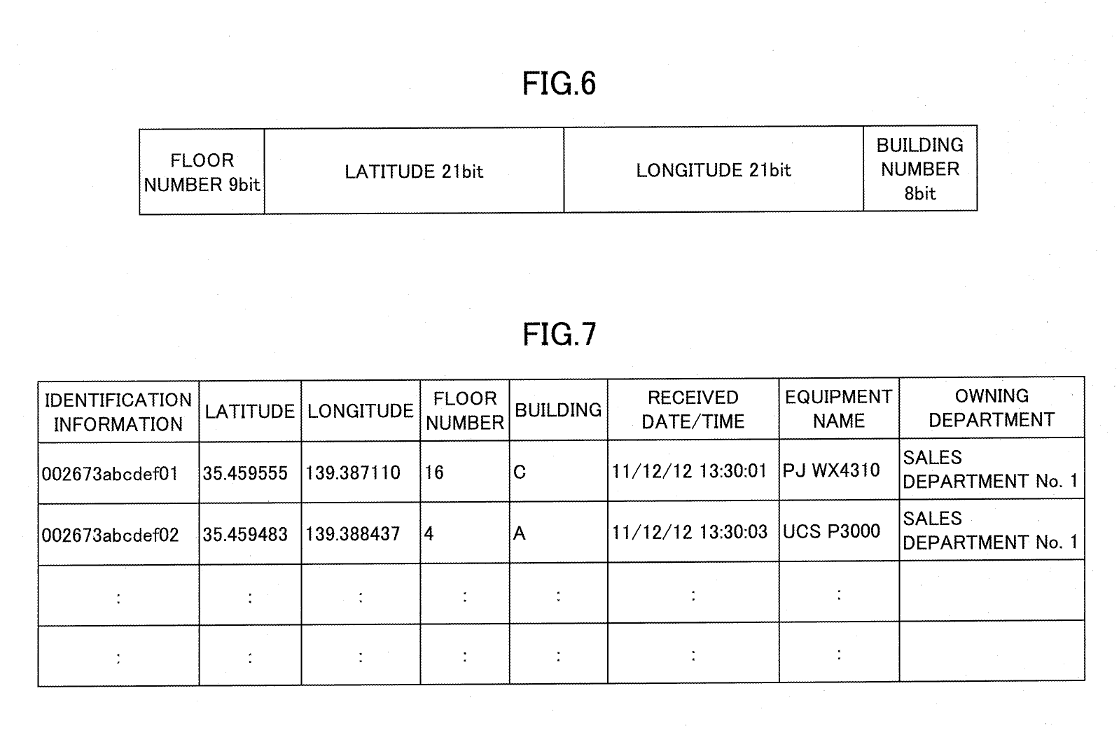

The position information receiving unit 328 receives the position information 302 transmitted from the communication apparatus 100. The position information 302 received is held in the storage unit 320 of the wireless terminal 120. The identification information transmitting unit 330 transmits, to the communication apparatus 100, the position information 324 with the identification information 322 of the wireless terminal 120. The position information 322 is transmitted to the wireless terminal 120 by a format as in FIG. 6, for example. In a format in FIG. 5, respective fields of the floor number, the latitude, the longitude, and the building number that are expressed with 9, 21, 21, and 8 bits, respectively, are formed such that they are linked to an applicable field of a message received according to the IMES standards. An expression format of each field conforms to the IMES standards. In practice, in addition to this format, checksum information and headers which are specified in accordance with communications schemes are added for transmission. As the communications schemes, IEEE 802.15.4 and ZigBee (registered copyright) standards are used, for example.

The acceleration detection unit 332 detects a change in acceleration of the wireless terminal 120. The change in acceleration is detected when the wireless terminal 120 starts a movement, when the movement is stopped, or when a slope is detected. The detected change in the acceleration is used for determining a timing of an operation of transmitting or receiving of the wireless terminal 120. The acceleration detection unit 332 is an arbitrary constituting element.

The control unit 334 controls a timing of receiving position information by the position information receiving unit 228 and a timing of transmitting the position information 324 and the identification information 322 by the identification information transmitting unit 330. The timings of transmitting and receiving are determined based on detection of a change in acceleration by the acceleration detecting unit 332. Alternatively, it may be determined based on an interval or a time set in advance to the wireless terminal 120. Moreover, the timings of transmitting and receiving may be determined independent of each other. Furthermore, when the wireless terminal 120 configures the PAN by ZigBee (registered trademark) with the communication apparatus 100 and the management apparatus 140, control is performed such that the wireless terminal 120 provides an endpoint function.

With the above-described configuration, the wireless terminal 120 according to one embodiment of the present invention efficiently receives position information from a communication apparatus and efficiently transmit it with the other information to the identification information communication apparatus.

When the wireless terminal 120 is an information terminal such as a smart phone or a PC, an input unit which accepts an input from a user or a display unit which presents information to the user may be provided. This makes it possible to present identification information or position information to the user and to input or modify identification information or position information from the user.

FIG. 3C is a functional block diagram of the management apparatus 140 according to one embodiment of the present invention. The management apparatus 140 in one embodiment of the present invention includes a communications unit 340, a conversion unit 346, and a control unit 348.

The communications unit 340 includes a receiving unit 342 and a transmitting unit 344. The receiving unit 342 receives data transmitted from the wireless terminal or the communication apparatus which belongs to the network 180. The transmitting unit 344 transmits the data converted in the management apparatus 140 to the management server 160 which belongs to the network 190. The network 180 is a PAN based on IEEE 802.15.4 and ZigBee (registered trademark) standards, for example. Moreover, the network 190 is a LAN based on IEEE 802.3 standards, for example.

The conversion unit 346 converts data received from the network 180 by the receiving unit 342 to a format which is adapted to the network 190. The converted data are transmitted to the management server 160 via the network 190 by the transmitting unit 344. Here, when the identification information of the wireless terminal 120 that is included in the data is expressed in the IEEE 802.15.4 short address, it is converted to an IEEE extended address based on information at the time of configuring the PAN.

The control unit 348 controls an operation of the management apparatus 140. When the management apparatus 140 configures a PAN by ZigBee (registered trademark) standards with the communication apparatus 100 and the wireless terminal 120, control is performed such that the management apparatus 140 provides a coordinator function.

With the above-described configuration, the management apparatus 140 according to one embodiment of the present invention may bridge communications between the network 180 to which the communication apparatus 100 and the wireless terminal 120 belong and a network 190 to which the management server belongs.

FIG. 3D shows a functional block diagram of the management server 160 according to one embodiment of the present invention. The management server 160 according to one embodiment of the present invention includes a communications unit 360, a storage unit 366, an input unit 370, a display unit 372, and a control unit 374.

The communications unit 360 includes a receiving unit 362 and a transmitting unit 364. The receiving unit 362 receives identification information and position information transmitted from the wireless terminal through the management apparatus 140. The received identification information and position information are stored in the storage unit 366. When requested to provide the position information to an external server, etc., the transmitting unit 364 transmits the position information to the external server, etc.

The storage unit 366 includes position management information 368. The position management information 368 is information in which management information such as received time, etc., is added to the identification information and the position information that are received from the wireless terminal 120. An example of a table storing therein the information is shown in FIG. 7. FIG. 7 includes items of identification information, equipment name, owning department, latitude, longitude, floor number, building, and received date/time. Identification information is information such as an IEEE extended address, for example, of the wireless terminal 120 which transmitted the identification information. The latitude, longitude, floor number, and the building correspond to the position information received with the identification information. The received date/time are date and time at which the management server 160 received the information. The equipment name is a name of an equipment unit of the wireless terminal 120 or a name of a unit to be managed that is assigned to the wireless terminal 120 which transmitted the information. The owning department is a name of a department which owns the wireless terminal 120 which transmitted the information. The information of the equipment name and the owning department are associated with the identification information by the management server 160 in advance.

In order for a user to search for the position information, the input unit 370 accepts an input from the user.

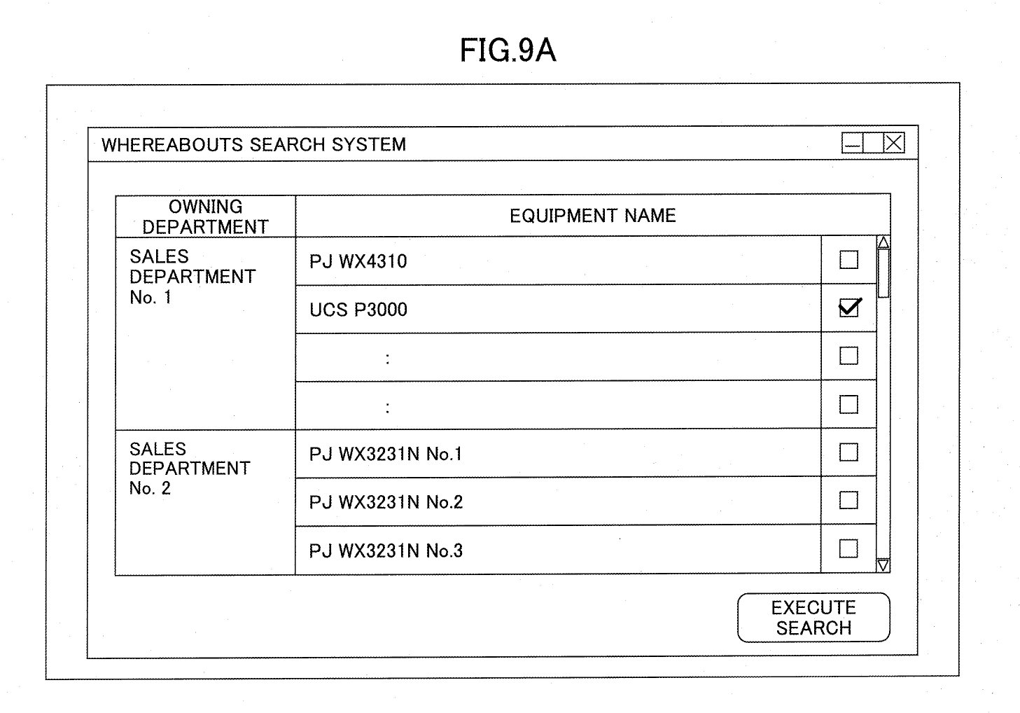

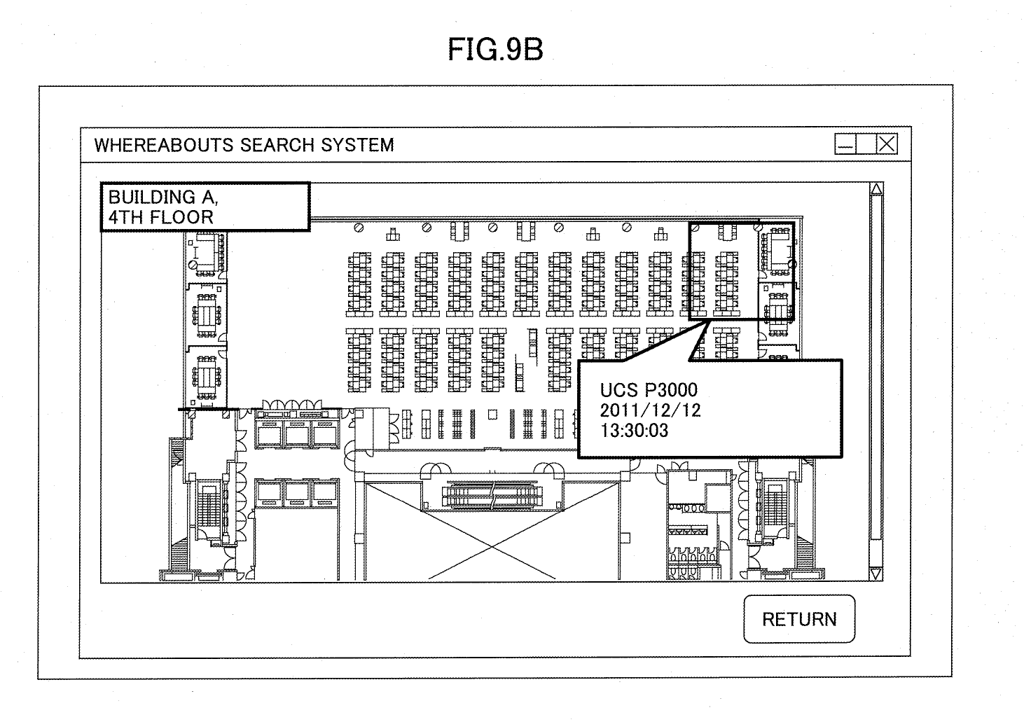

The display unit 372 displays, on a screen, a GUI related to a search screen for the user to search for the position information. An example of the search screen is shown in FIG. 9A. In “a whereabouts search system” shown in FIG. 9A, an owning department and an equipment name that are related to the wireless terminal are displayed in a list on a screen based on information stored in the storage unit 366. When the user selects via the input unit 370 a check box for an equipment unit to be searched for, a check mark is assigned. When “a search execution” button is selected after placing check marks for all equipment units to be searched for, a search is executed, switching to a screen for displaying results. In an example in FIG. 9A, an example in which a user executes a search is shown for an equipment unit of “UCS P3000”, which is owned by “Sales No. 1 Department”. FIG. 9B is an example of a screen of the search results. When “a search execution” button is selected, based on data stored in the storage unit 366, the display unit 372 displays a floor plan of “A building 4th floor” on which “UCS P3000” is located, a name of an equipment unit thereof, and received date/time.

The control unit 374 controls an operation of the management server 160.

With the above-described configuration, the management server 160 according to one embodiment of the present invention may manage a position of the wireless terminal and search for whereabouts thereof. In particular, information itself which shows the position itself of the wireless terminal may be received directly to manage it, making it possible to reduce a computational complexity associated with the search for the position.

The management server 160 may include the same functions as those of the receiving unit 342, the control unit 348, and the conversion unit 346 included by the management apparatus 140 and may include the same functions as the management apparatus 140. This makes it unnecessary to individually provide the management apparatus 140.

Moreover, the position management information 368 which is stored by the management server 160 may store information including an electric field strength or a time taken for arrival of information, identifier of management apparatus or communication apparatus passed through, and date/time at which the wireless terminal transmitted the information, together with or in lieu of information shown in FIG. 7. In this way, position information may be managed under more precise conditions.

Moreover, the management server 160 may record previous position information of the wireless terminal. In this way, a movement of the wireless terminal may be tracked.

(4. Operational Sequence)

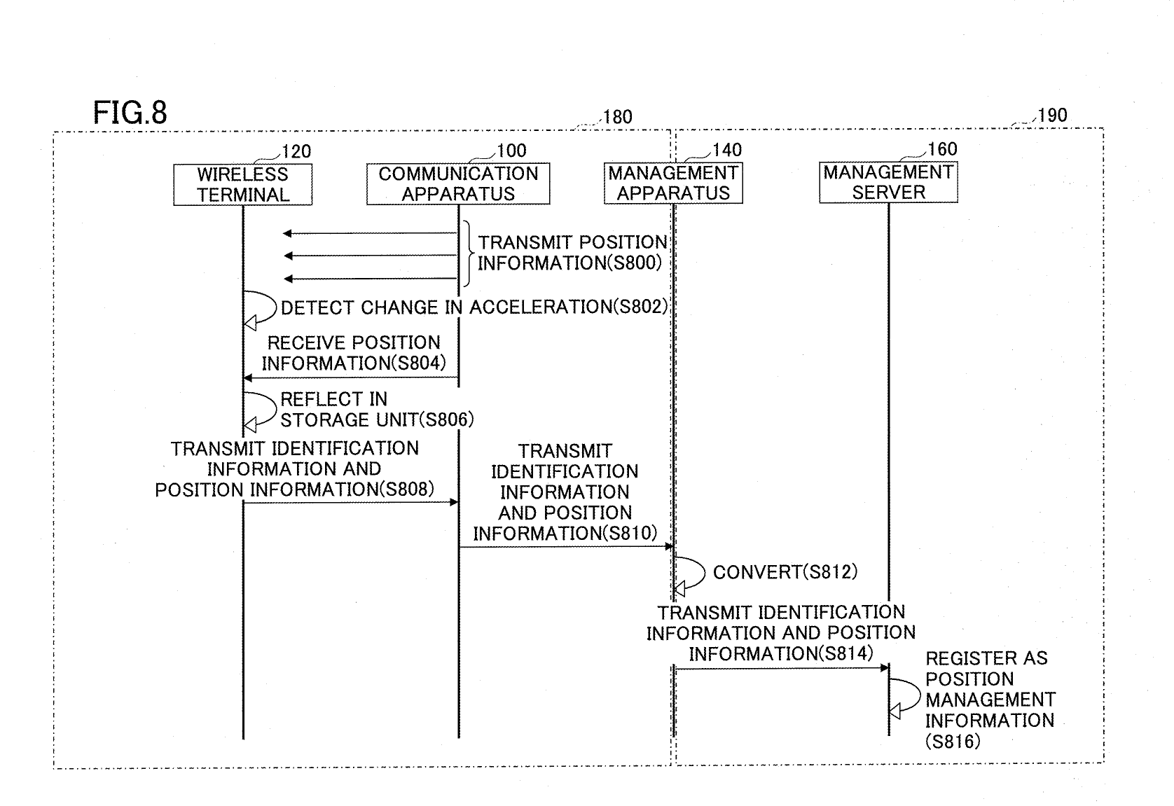

FIG. 8 is a diagram showing an operational sequence of the position information management system 1 according to one embodiment of the present invention in a configuration in FIGS. 1A and 1B. In FIG. 8 is shown an example which includes the communication apparatus 100 which, upon sensing a change in acceleration, receives the position information and transmits the identification information; the wireless terminal 120 which transmits the position information to an area to which the communication apparatus 100 belongs; the management apparatus 140 which bridges a PAN (IEEE 802.15.4 and ZigBee (registered copyright)) and a LAN (IEEE 802.3); and the management server 160. The PAN between the communication apparatus 100, the wireless terminal 120, and the management apparatus 140 is to be already established.

In step S800, the communication apparatus 100 consecutively or intermittently transmits the position information using IMES, etc.

In step S802, the wireless terminal 120 senses a change in acceleration.

In step S804, the wireless terminal 120 receives the position information transmitted from the communication apparatus 100.

In step S806, the wireless terminal 120 stores the position information received.

In step S808, the wireless terminal 120 transmits the identification information and the position information to the communication apparatus 100.

In step S810, the communication apparatus 100 transmits the identification information and the position information received from the wireless terminal 120 to the management apparatus 140 via a minimum route.

In step S812, the management apparatus 140 converts data transmitted from the network 180 that include the identification information and the position information received from the communication apparatus 100 to a format adapted to the network 190.

In step S814, the management apparatus 140 transmits, to the management server 160, the identification information and the position information that are converted to a format adapted to the network 190.

In step S816, the management server 160 registers the identification information and the position information received from the management apparatus 140, together with information on the wireless terminal that corresponds to the identification information.

With the above-described procedure, in the position information management system 1 according to one embodiment of the present invention, a wireless terminal may efficiently transmit the identification information and the location information to a nearby communication apparatus to suppress power consumption of the wireless terminal.

As described above, the management server 160 may execute a function of the management apparatus 140 in an integrated manner. In this case, it becomes unnecessary to separately install the management apparatus 140.

Moreover, when the wireless terminal is not provided with the acceleration detecting unit 332, step S802 is not executed and reception of the position information in step S804 may be performed at a predetermined time or a predetermined interval. The subsequent process is the same as in steps S806-S816.

### Embodiment 2

Next, Embodiment 2 is described.

First, as described above, the wireless terminals 120 (including the above-described wireless terminals 122 and 124) may be not an active tag itself, but a wireless terminal which has a function equivalent to the active tag, such as a smart phone, a PDA, a PC, a smart meter, etc. This makes it possible to manage position information of an existing wireless terminal 120 without affixing the active tag for an object whose position is to be managed.

For example, when the wireless terminal 120 is a smart phone, the smart phone has a function equivalent to the active tag, so that the smart phone may realize the above-described function without separately affixing the active tag.

In other words, the communication apparatus 100 first transmits position information continuously or intermittently using an IMES, etc. The smart phone, which is the wireless terminal 120, receives position information from the communication apparatus 100 installed on a ceiling, etc. The smart phone stores the position information received and transmits identification information and the position information to the communication apparatus 100. Then, as a result of the identification information and the position information having been transmitted by the management server 160 eventually, the management server 160 can manage the position (whereabouts) of the smart phone by registering the identification information and the position information together with information of the wireless terminal corresponding to the identification information.

Now, in the above-described embodiment 1, a format (for example, see FIGS. 4-6) including position information 302 which complies with the IMES standards is used to implement transmitting and receiving of the position information. Therefore, needless to say, each apparatus (the communication apparatus 100, the wireless terminal 120, etc.) which makes up the position information management system 1 supports the IMES standards and conducts transmitting and receiving of the position information in accordance with the IMES standards.

Here, in the Embodiment 2, in a format (compliant with IMES standards) that includes the position information 302 shown in the above-described Embodiment 1, the field is to be extended. In the IMES standards, from the standards standpoint, it is possible to extend (add) information to be transmitted and received within a certain range by a vendor, etc. In the Embodiment 2, on a format which includes the position information 302, an area for storing information to be transmitted and received is extended to include information on operation control. In this way, operation control for the radio terminal 120 is realized in a position information management system 1. Below details are described.

### Example 1 of Extended Format

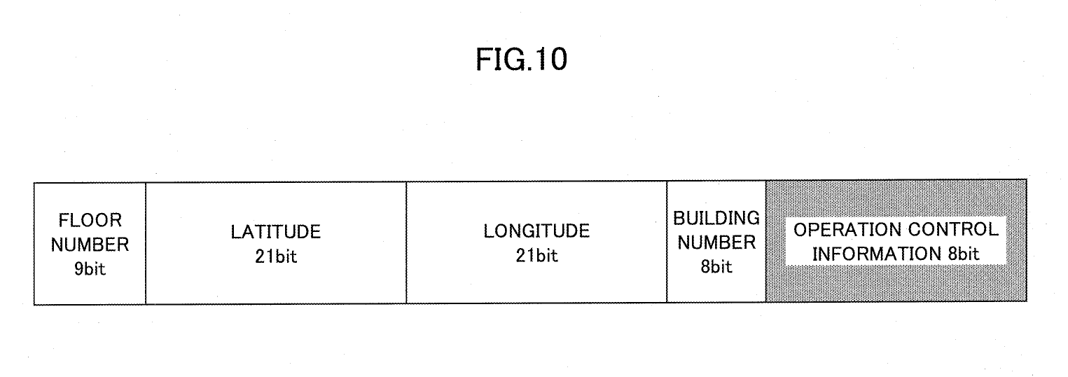

FIG. 10 shows an example of an extended format which includes position information transmitted and received between the communication apparatus and the wireless terminal according to one embodiment of the present invention. As seen from a comparison in FIGS. 4 and 5, in the present extended format, floor number, latitude, longitude, and building number, and the additional field of “operation control information” are respectively represented with 9, 21, 21, 8, and 8 bits. An expression format for each field is compliant with IMES standards.

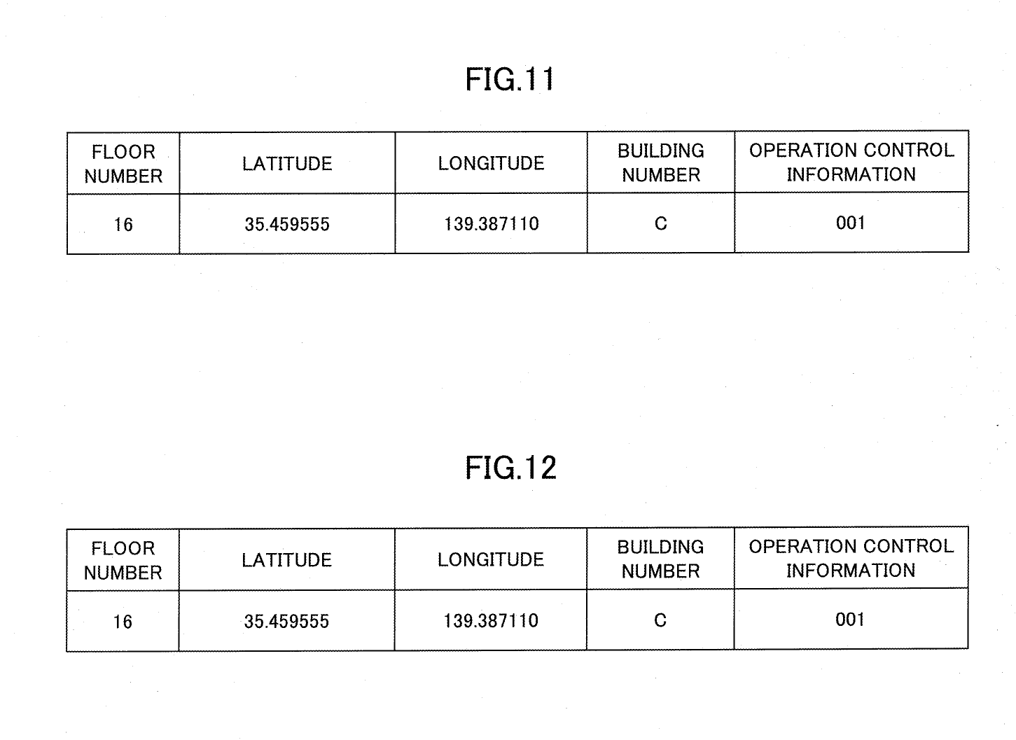

FIG. 11 is one example of position information and extension information which are held by the communication apparatus according to one embodiment of the present invention. Moreover, FIG. 12 shows one example of position information and extension information which are held by the wireless terminal in one embodiment of the present invention. When the position information is transmitted based on the extended format in FIG. 10 from the communication apparatus 100 to the wireless terminal 120, as the extended format includes extension information (“operation control information”, for example), in addition to the position information, the extension information is also transmitted from the communication apparatus 100 to the wireless terminal 120, so that, as a result, the same information is also held on the wireless terminal 120 side.

### Example of Operation Control Content by “Operation Control Information”

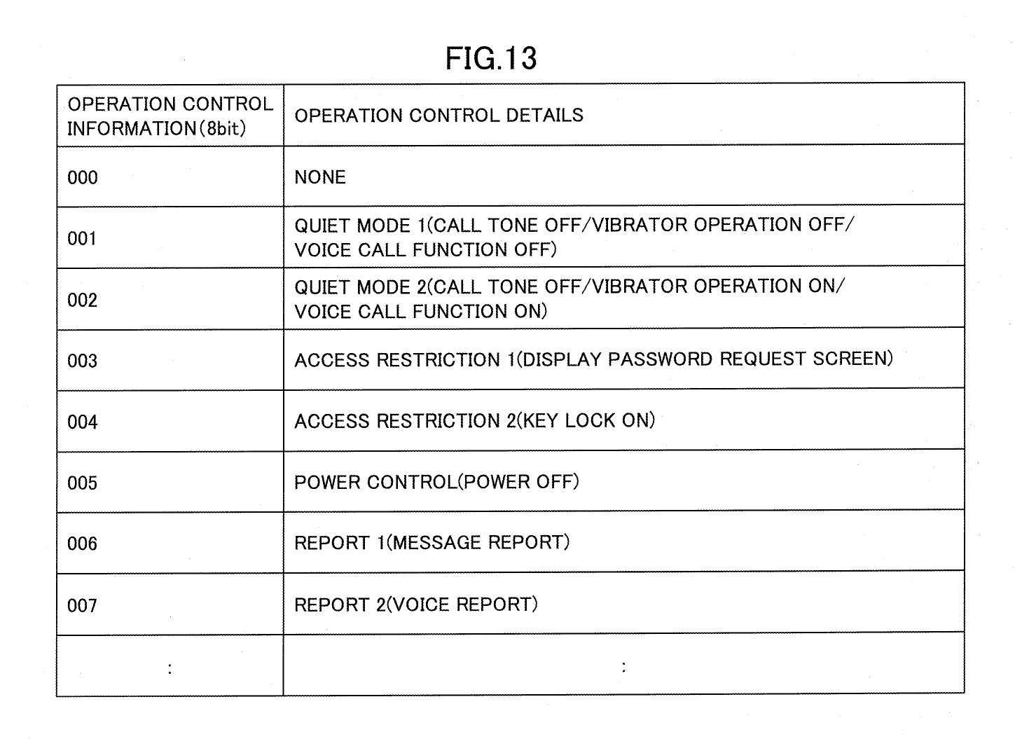

FIG. 13 shows an example of content of operation control content by “operational control information” according to one embodiment of the present invention. Here, the “operation control information”, which is one example of the extension information, indicates operation control information for the wireless terminal 120, so that, in accordance with the “operation control information”, operation control content for the wireless terminal 120 is specified in advance.

A value (for example, 001, 002, . . . ) of the “operation control information” is initially set by an administrator, etc., so that the “operation control information” is held in the communication apparatus 100 and then transmitted from the communication apparatus 100 to the wireless terminal 120. Then, when the wireless terminal 120 receives the “operation control information” from the communication apparatus 100, the wireless terminal 120 carries out operation control for the wireless terminal 120 in accordance with received “operation control information” (a value of “operation control information”).

For example, when the administrator, etc., consider stopping all usage for a smart phone, which is a wireless terminal 120 residing in a restricted position (a meeting room, a hall, a movie theater, for example) where generation of noise is severely restricted, initially, along with the position information 302 (FIG. 3A) within the storage unit 300 of the communication apparatus 100 installed at the restricted position, “the operation control information” of 001 is set (stored), for example.

Thereafter, when the smart phone is within the restricted position, it receives “the operation control information” of 001 along with the position information 302 (FIG. 3A) from the communication apparatus 100 installed there.

In accordance with “the operation control information” received, the smart phone controls an operation of an own apparatus as in the operation control content (FIG. 13) that corresponds to the same “operation control information” of 001. In other words, the smart phone controls the operation of the own apparatus to a quiet mode 1 (call tone OFF/vibrator operation OFF/voice call function OFF).

For the wireless terminal 120 such as the smart phone, the operation control content (FIG. 13) that corresponds to “the operation control information” is known information.

(Operation of Wireless Terminal 120)

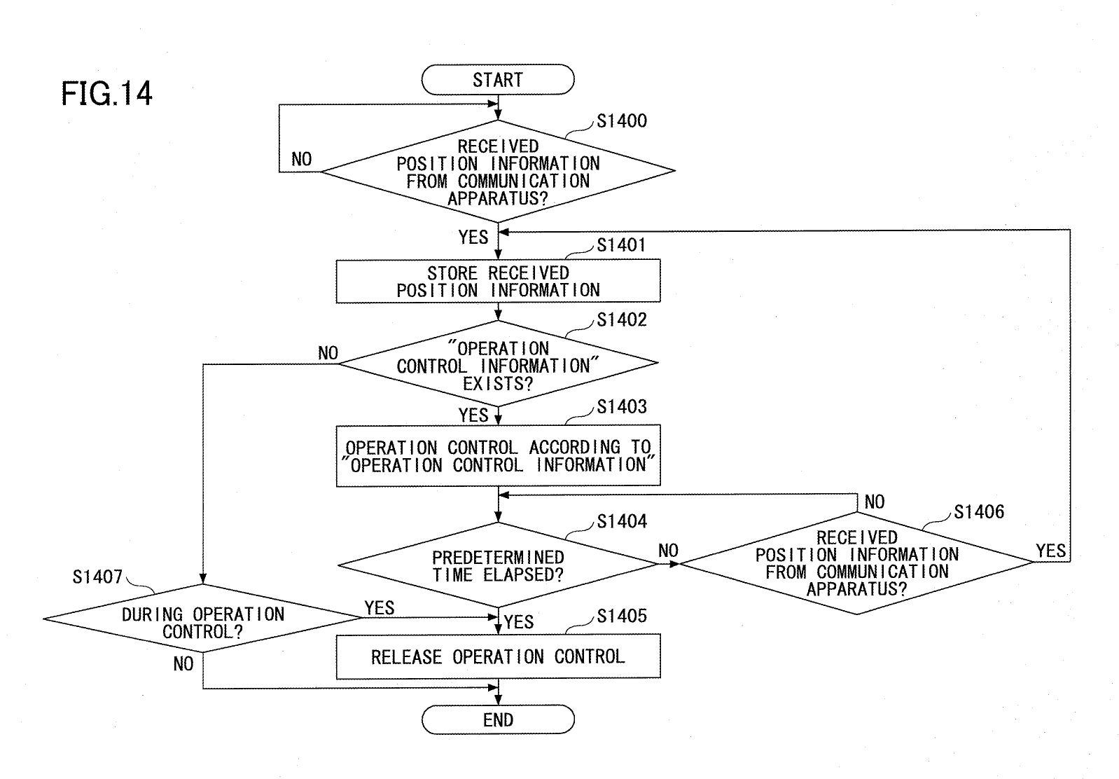

FIG. 14 is a flowchart showing an operation of the wireless terminal 120 in the present Embodiment 2. An operation entity of the flowchart is the control unit 334 of the wireless terminal 120.

As described above, the control unit 334 in the present Embodiment 2 controls a timing of receiving of position information by the position information receiving unit 238 and a timing of transmitting of position information 324 and identification information 322 by the identification information transmitting unit 330 and also carries out operation control of an own apparatus in accordance with “the operation control information”. Explanations are given below.

In step S1400, the control unit 334 of the wireless terminal 120 determines whether the position information is received from the communication apparatus. For example, when the communication apparatus 100 is installed on the ceiling, etc., the wireless terminal 120 receives position information 302 from the communication apparatus 100 when it is positioned within a range in which the position information thereof arrives. The position information 302 from the communication apparatus 100 is transmitted based on the extension format, so that the position information 302 transmitted includes extension information (“operation control information”) (see FIG. 11).

In step S1401, the control unit 334 stores the position information 324 received into the storage unit 320. The position information 324 is received based on the extended format, so that it includes extension information (“operation control information”). (FIG. 12)

In step S1402, the control unit 334 refers to the position information 302 transmitted thereto, or the position information 324 stored into the storage unit 320 and determines presence/absence of “the operation control information”. When “the operation control information” exists, the process proceeds to S1403.

On the other hand, when “the operation control information” does not exist, the process proceeds to S1407. In step S1407, the control unit 334 determines whether it is during operation control. If it is during operation control, the process proceeds to S1405, where operation control which is undergoing is released. If it is not during operation control, the process proceeds to END.

In step S1403, the control unit 334 carries out operation control according to “the operation control information”. For example, for “the operation control information” of 001, an operation of an own apparatus is controlled to a quiet mode 1 (call tone OFF/vibrator operation OFF/voice call function OFF).

In step S1404, the control unit 334 determines whether a predetermined time (a certain time) has elapsed since a time at which it received position information previously. The predetermined time is determined to be a value larger than a timing interval for the communication apparatus to transmit position information to the wireless terminal 120. The predetermined time elapsed represents that the position information has not been received from the communication apparatus, which may mean that the wireless terminal 120 is no longer under control of the communication apparatus (is not at a position to which the position information of the communication apparatus may reach).

In step S1405, the control unit 334 releases operation control. Releasing means following an operation set in the apparatus itself inherently. For example, in S1403, when an operation of an own apparatus is controlled to change from a normal mode to a quiet mode 1 (call tone OFF/a vibrator operation OFF/a voice call function OFF), it may suffice to conduct control which causes a return to a normal mode, which is an operation mode set in the apparatus itself inherently.

In step S1406, the control unit 334 of the wireless terminal 120 determines whether the position information has been received from the communication apparatus. While the communication apparatus transmits the position information at a predetermined interval to the wireless terminal 120, when the wireless terminal 120 still stays in the same position, for example, it receives the position information 302 from the same communication apparatus again repeatedly. When the wireless terminal 120 stays under the control of the communication apparatus 100, the position information 302 from the communication apparatus 100 is the same as the position information received in S1400.

### Specific Examples

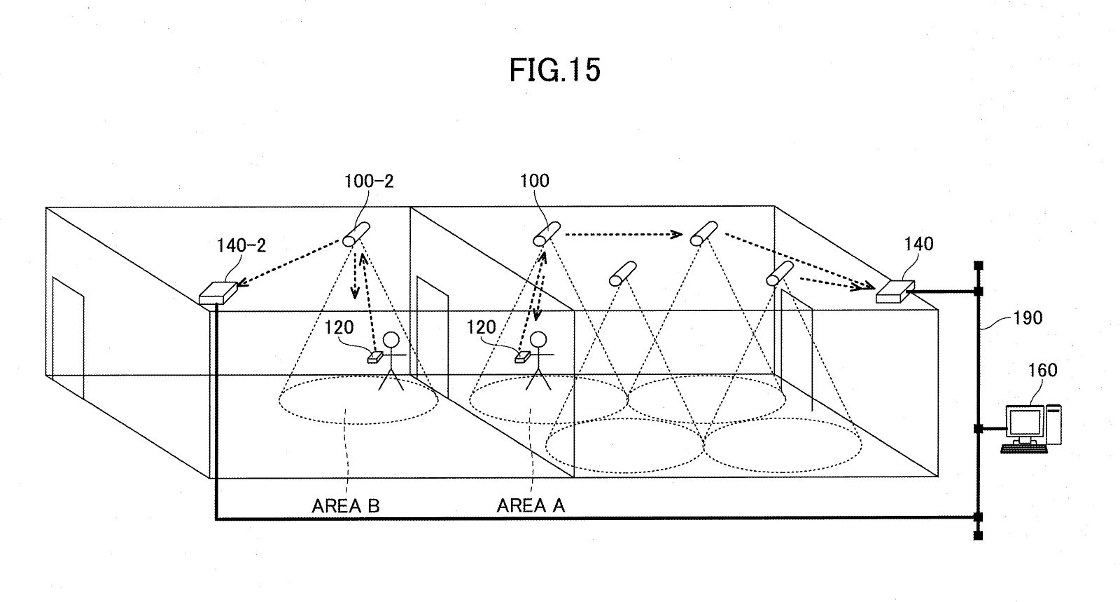

FIG. 15 shows position information management system 1-2 which explains one embodiment in the present embodiment 2. In the position information management system 1-2, a user holds a smart phone, which is the wireless terminal 120. Moreover, a case is envisaged in which first a user is positioned in an area A and then moves to an area B.

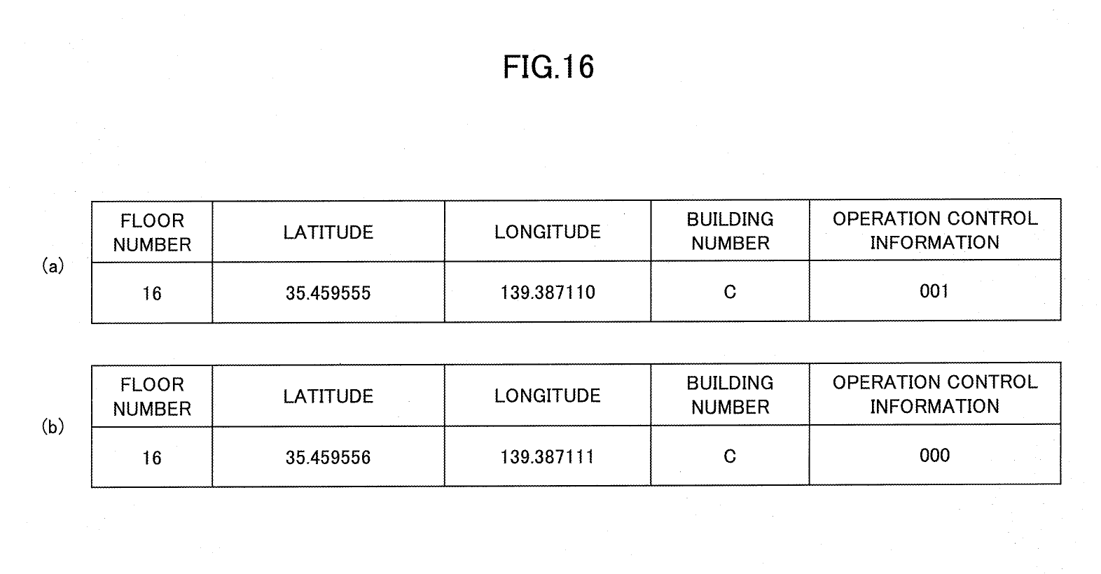

FIG. 16 shows position information of the communication apparatus 100 and position information of a communication apparatus 100-2 according to one embodiment of the present invention. As shown in (a) in FIG. 16, while the communication apparatus 100 is installed on a ceiling of the area A, the area A (a room in the area A) is a restricted position in which generation of noise is severely restricted, so that the administrator, etc., set the “operation control information” to “001”.

On the other hand, as shown in (b) in FIG. 16, while the communication apparatus 100-2 is installed on a ceiling of the area B, which is outside a restricted position in which generation of noise is severely restricted, the administrator, etc., set the “operation control information” to “000”.

First the user is positioned in the area A and the wireless terminal 120 (for example, a smart phone) held by a user receives position information from the communication apparatus 100 in the area A. The position information (including “operation control information”) stored by the communication apparatus 100 is the same as in (a) in FIG. 16, so that, then, the position information (including “the operation control information”) received from the communication apparatus 100 by the wireless terminal 120 is the same as in (a) in FIG. 16.

The wireless terminal 120 stores the received position information 324 in the storage unit 320 ((a) in FIG. 16). The wireless terminal 120 refers to the position information 324, refers to “the operation control information” of 001, and controls an operation of an own apparatus to “quiet mode 1 (call tone OFF/vibrator operation OFF/voice call function OFF)”.

While a user continues to wait in the area A, the wireless terminal 120 continues to receive position information from the communication apparatus 100 at a certain timing interval. During this time, the wireless terminal 120 continues to control the operation of the apparatus to be the quiet mode 1 (call tone OFF/vibrator operation OFF/voice call function OFF).

Next, the user moves to the area B while holding the wireless terminal 120. In the area B, the wireless terminal 120 this time receives position information from the communication apparatus 100-2. The position information (including “operation control information”) stored by the communication apparatus 100 is the same as in (b) in FIG. 16, so that, then, the position information (including “the operation control information”) received from the communication apparatus 100-2 by the wireless terminal 120 is the same as in (b) in FIG. 16.

The wireless terminal 120 stores the received position information 324 in the storage unit 320 ((b) in FIG. 16).

The wireless terminal 120 refers to the position information 324, refers to “the operation control information” of 000, and controls an operation of an own apparatus to “No”. “No” means operation release for no operation control or during operation control and means following an operation set in the apparatus itself inherently. For example, if an operation of the smart phone is set to a normal mode by a user, control is conducted which causes a return to the normal mode, which is an operation mode set in the apparatus itself inherently.

As described above, even when the wireless terminal 120 fails to receive position information for at least a predetermined time, it follows an operation set in the apparatus itself inherently (steps 1404, 1405). Thus, if the area B does not exist, the wireless terminal 120 never receives “the operation control information” of 000. However, once at least the predetermined time elapses, the smart phone conducts control which causes a return to the normal mode, which is an operation mode set in the apparatus itself inherently.

### Example 2 of Extended Format

Next, Example 2 of the extended format is explained.

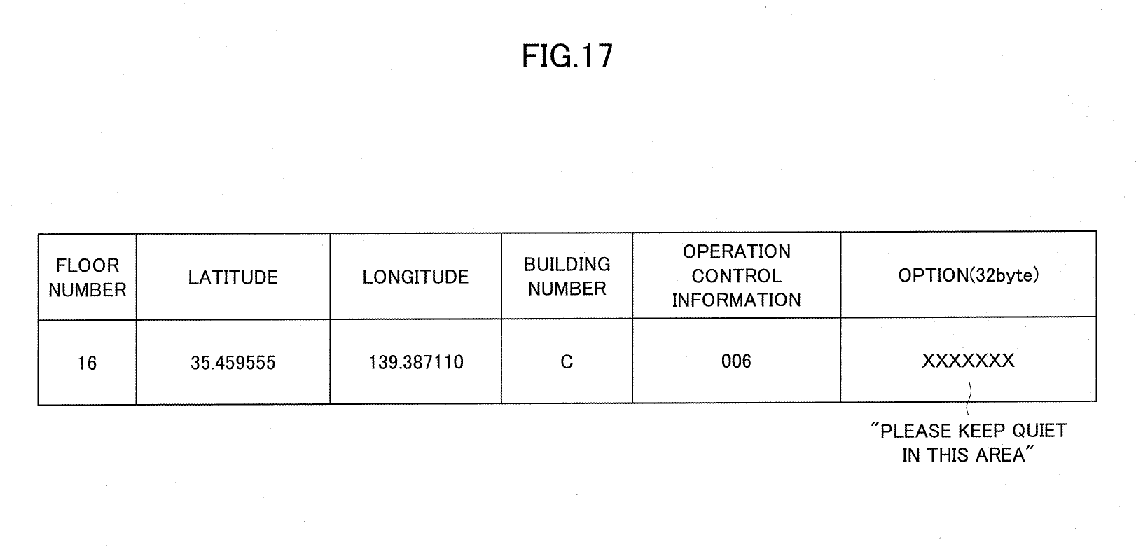

FIG. 17 shows an example of an extended format which includes position information transmitted and received between the communication apparatus and the wireless terminal. As seen also from a comparison with FIG. 10, in the present extended format, “an option” field is further extended (added), so that it is expressed in 32 bytes, for example.

Here, “an option” is “an option” for “operation control information”. For example, for “the operation control information” of 006, content of operation control of “report 1 (message report)” is to be carried out. Then, in “the option” here, content of message to be reported may be designated arbitrarily. As in FIG. 10, when the content of the message to be reported may not be designated with “the option”, specified message content may be displayed.

Therefore, in such a case, the smart phone, which is the wireless terminal 120, conducts display reporting of “please keep quiet in this area!” on a display screen, etc., of an own apparatus when position information is received including “the operation control information” of 006 and “the option” of “please keep quiet in this area”. In this way, “the operation control information” can be extended in a variety of ways.

“The operation control information” in FIG. 13 is merely one example. Besides the above, depending on individual devices which are implemented as the wireless terminal 120, “the operation control information” and operation control content may be arbitrarily specified and extended. Then, “the option” also may be specified arbitrarily in accordance with “the operation control information”.

Moreover, in the extended format in FIG. 17, “the option” field is expressed in 32 bytes; however, depending on content of “the option”, more fields may become necessary. For example, when trying to designate simply more message content with “the option”, more fields become necessary in a corresponding manner. In order to deal with this, on the wireless terminal side, a number of combinations designated in advance with “the option” and message content are collated, so that the collated results are held. In this case, in “the option” field of the extension format, it suffices to designate only a number to which is collated message content to be displayed on the wireless terminal side (for example, it is not necessary to designate a letter sequence such as “please keep quiet in this area”, for example). In this case, in the extended format in FIG. 17, it is possible to cause much message content to be displayed on the wireless terminal side in a very few “option” fields (for example, 8 bits, etc.).

(Overall)

In the foregoing, the present embodiment makes it possible to provide a position information management system which efficiently manages position information. The present invention is not limited to a specific embodiment, so that variations and changes are possible within a scope of a gist of the present invention that is recited in the claims.

The present application is based on Japanese Priority Application No. 2012-122377 filed on May 29, 2012, the entire contents of which are hereby incorporated by reference.

1. A position information management system which includes a communication apparatus and a wireless terminal which communicates with the communication apparatus, wherein the communication apparatus includes
a storage unit which stores therein position information of the communication apparatus and operation control information which is determined in accordance with the position information of the communication apparatus and which controls an operation of the wireless terminal; and
a position information transmitting unit which transmits, to the wireless terminal, the position information and the operation control information stored in the storage unit, and wherein the wireless terminal includes
a position information receiving unit which receives the position information and the operation control information by the communication apparatus; and
an operation control unit which controls an operation of the wireless terminal in accordance with the operation control information received by the position information receiving unit.

2. The position information management system as claimed in claim 1, wherein the position information transmitting unit transmits, to the wireless terminal, the position information and the operation control information in compliance with IMES standards.

3. The position information management system as claimed in claim 2, wherein the operation control information is stored in an extended format including the position information.

4. The position information management system as claimed in claim 3, wherein the operation control information includes option information of the operation control information; and wherein the operation control unit controls the operation of the wireless terminal in accordance with the operation control information and the option information that are received by the position information receiving unit.

5. The position information management system as claimed in claim 1, wherein, if the operation control information is not received for a certain interval after the operation control information is previously received by the position information receiving unit, a control of the operation is released.

6. The position information management system as claimed in claim 1, wherein the position information management system includes a management server which manages the position of the wireless terminal; wherein
the communication apparatus includes
a terminal information receiving unit which receives the position information and the identification information of the wireless terminal that are transmitted from the wireless terminal which received the position information of the communication apparatus; and
a terminal information transmitting unit which transmits the identification information and the position information to the management server; wherein
the wireless terminal includes
an identification information transmitting unit which transmits, to the communication apparatus, the identification information of the wireless terminal together with the position information received; and wherein
the management server includes
a receiving unit which receives the identification information and the position information from the communication apparatus; and
a managing unit which manages a position of the wireless terminal by the identification information and the position information.

7. A position information management method in a position information management system which includes a communication apparatus, and a wireless terminal which communicates with the communication apparatus, wherein the communication apparatus performs the steps of
storing, in a storage unit, position information of the communication apparatus and operation control information which is determined in accordance with the position information of the communication apparatus and which controls an operation of the wireless terminal; and
transmitting, to the wireless terminal, the position information and the operation control information stored in the storage unit, and wherein
the wireless terminal performs the steps of
receiving the position information and the operation control information by the communication apparatus; and
controlling the operation of the wireless terminal in accordance with the operation control information received.

8. A communication apparatus which communicates with a wireless terminal, comprising:
a storage unit which stores therein position information of the communication apparatus and operation control information which is determined in accordance with the position information of the communication apparatus and which controls an operation of the wireless terminal; and
a position information transmitting unit which transmits, to the wireless terminal, the position information and the operation control information stored in the storage unit.
